(19) United States
(12) Patent Application Publication
(10) Pub. No.: US 2011/0013310 A1
(43) Pub. Date: Jan. 20, 2011

(54) RECORDING MEDIUM DRIVING DEVICE AND MAGNETIC RECORDING MEDIUM, AND METHOD FOR CONTROLLING FLYING HEIGHT OF HEAD ELEMENT

(75) Inventors: Masaharu SUGIMOTO, Kawasaki-shi (JP); Takuya KOBAYASHI, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/891,673

(22) Filed: Sep. 27, 2010

Related U.S. Application Data
(63) Continuation of application No. PCT/JP2008/055842, filed on Mar. 27, 2008.

(51) Int. Cl. G11B 21/02; G11B 5/82

(52) U.S. Cl. 360/75; 360/135; G9B/21.003; G9B/5.293

(57) ABSTRACT

According to one embodiment, a recording medium driving device includes: a recording medium including a plurality of groove regions and land regions, wherein each of the groove regions is formed in a groove formed on top surface of the recording medium and having an arrangement of a magnetic domain formed for each bit, and each of the land regions forms a flat surface on the top surface of the recording medium and in between a pair of the groove regions in adjacency; a head slider disposed to face the top surface of the recording medium; a head element mounted on the head slider; a heater mounted on the head slider and configured to cause a projection in the head element by heat; and a control circuit configured to cause the projection to contact with the land region at time of performing zero calibration for the projection.

### CROSS-REFERENCE TO RELATED APPLICATIONS

This application is a continuation of PCT international application Ser. No. PCT/JP2008/055842 filed on Mar. 27, 2008 which designates the United States, incorporated herein by reference.

### FIELD

Embodiments described herein relate generally to a recording medium driving device and a magnetic recording medium, and a method and a circuit for controlling a flying height of a head element.

### BACKGROUND

In a head slider are embedded a head element and a heater. On the top surface of the head slider is formed a protective film of, for example, diamond-like carbon (DLC). The protective film covers a reading gap and a writing gap of the head element. The heater heats up the head element. Due to heat expansion of the heater and the head element, the reading gap and the writing gap of the head element project toward a magnetic disk. Thus, the flying height of the head element is set according to a projection amount thereof.

In order to set the projection amount, what is known as the zero calibration is performed. In the zero calibration, the projection amount of the head element is gradually increased. Then, a projection amount of the head element is identified at the time when the protective film makes contact with the magnetic disk. Based on the identified projection amount, the projection amount of when a reading or a writing is performed is determined. Thus, in the zero calibration, the contact between the protective film and the magnetic disk needs to be detected in a reliable manner.

For example, a bit patterned medium includes groove regions having grooves. In the grooves of the groove regions are arranged nanomagnetic particles. For each of bits established by the nanomagnetic particles, a magnetic domain is formed. On the top surface of such groove regions, minute surface irregularities are formed corresponding to the shapes of the nanomagnetic particles. In the zero calibration, if the projection of the head element repeatedly makes contact with the surface irregularities in the groove region; then the protective film is worn thereby causing degradation in the property of the head element.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic plan view of an internal configuration of a recording medium driving device according to a first embodiment;

FIG. 2 is an exemplary schematic enlarged perspective view of a flying head slider in the embodiment;

FIG. 3 is an exemplary schematic front view of an element containing film viewed from an air outflow side of an air bearing surface in the embodiment;

FIG. 4 is an exemplary cross-sectional view along line 4-4 illustrated in FIG. 3;

FIG. 5 is an exemplary schematic cross-sectional view of the element containing film for illustrating a “projection” formed on the flying head slider in the embodiment;

FIG. 6 is another exemplary schematic cross-sectional view of the element containing film for illustrating the “projection” formed on the flying head slider in the embodiment;

FIG. 7 is an exemplary schematic plan view of a magnetic disk in the embodiment;

FIG. 8 is an exemplary schematic enlarged cross-sectional view along line 8-8 illustrated in FIG. 7;

FIG. 9 is an exemplary schematic block diagram of a control system of the recording medium driving device in relation to an electromagnetic conversion element and an electrically-heated wire mounted on the flying head slider in the embodiment;

FIG. 10 is an exemplary schematic enlarged cross-sectional view of a condition when the “projection” formed on the flying head slider makes contact with a land region in a zero calibration in the embodiment;

FIG. 11 is an exemplary schematic enlarged cross-sectional view of a manufacturing process of the magnetic disk in the embodiment;

FIG. 12 is another exemplary schematic enlarged cross-sectional view of a manufacturing process of the magnetic disk in the embodiment;

FIG. 13 is an exemplary schematic enlarged cross-sectional view of a magnetic disk according to a second embodiment;

FIG. 14 is an exemplary schematic enlarged cross-sectional view of a condition when the “projection” formed on a flying head slider makes contact with a land region in a zero calibration in the embodiment;

FIG. 15 is an exemplary schematic enlarged cross-sectional view of a magnetic disk according to a third embodiment;

FIG. 16 is an exemplary schematic enlarged cross-sectional view of a manufacturing process of the magnetic disk in the embodiment; and

FIG. 17 is an exemplary schematic enlarged cross-sectional view of a magnetic disk according to a fourth embodiment.

### DETAILED DESCRIPTION

In general, according to the one embodiment, a recording medium driving device comprising: a recording medium including a plurality of groove regions and a plurality of land regions, wherein each of the groove regions is formed in a groove that is formed on top surface of the recording medium and that has an arrangement of a magnetic domain formed for each bit, and each of the land regions forms a flat surface on the top surface of the recording medium and in between a pair of the groove regions in adjacency; a head slider disposed to face the top surface of the recording medium; a head element mounted on the head slider; a heater mounted on the head slider and that is configured to cause a projection in the head element by heat; and a control circuit configured to cause the projection of the head element to contact with the land region at time of performing zero calibration for the projection.

According to another embodiment of the invention, a head-element flying height control method comprising: positioning a head slider on a land region, the land region forming a flat surface on top surface of a recording medium and in between each pair of groove regions in adjacency from among a plurality of groove regions each formed in a groove that is formed on the top surface of the recording medium and that has an arrangement of a magnetic domain formed for each bit; and causing a projection of a head element mounted on the head slider to contact with the land region by increasing a projection amount of the head element.

According to still another embodiment of the invention, a magnetic recording medium comprising: a substrate; a plurality of groove regions, each formed in a groove that is formed on top surface of the substrate and that has an arrangement of a magnetic domain formed for each bit; a plurality of land regions, each forming a flat surface on the top surface of the substrate and in between a pair of the groove regions in adjacency; and a magnetic layer that is configured to be formed on the top surface of the substrate within the land region and that is configured to store magnetic information.

According to still another embodiment of the invention, a head-element flying height control circuit comprising: a positioning module configured to position a head slider on a land region, the land region forming a flat surface on top surface of a recording medium and in between each pair of groove regions in adjacency from among a plurality of groove regions each formed in a groove that is formed on the top surface of the recording medium and that has an arrangement of a magnetic domain formed for each bit; a detecting module configured to cause a projection in a head element mounted on the head slider and to detect a contact between the projection of the head element and the land region; and a control module configured to control, while reducing a projection amount of the head element, the projection amount of the head element depending on an output of magnetic information read from the recording medium.

Various embodiments according to the invention will be described hereinafter with reference to the accompanying drawings.

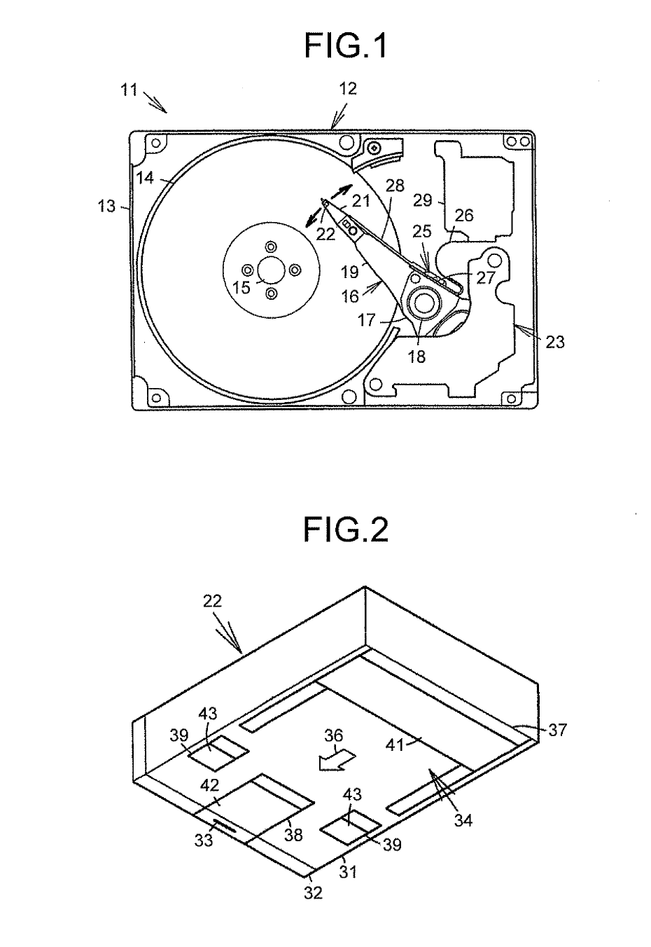

FIG. 1 is an exemplary plan view of an internal configuration of an HDD 11 as a specific example of a recording medium driving device according to one embodiment. The HDD 11 comprises a casing or housing 12 with a boxlike base 13 and a cover (not illustrated). The base 13 defines, for example, a flat cuboid internal space as a housing space and can be manufactured by performing casting of metal material of, for example, aluminum. The cover is attached to the opening of the base 13 so that the housing space gets sealed between the cover and the base 13. The cover can be manufactured by, for example, press-working a single sheet of plate material.

In the housing space is disposed one or more magnetic disks 14 each functioning as a recording medium. The magnetic disks 14 are mounted on the rotary shaft of a spindle motor 15, which causes the magnetic disks 14 to rotate at a high speed of, for example, 5400 revolutions per minute (rpm), 7200 rpm, 10000 rpm, or 15000 rpm.

In the housing space is also disposed a carriage 16 comprising a carriage block 17 that is rotatably linked to a vertically-extending spindle 18. In the carriage block 17 are defined a plurality of carriage arms 19 that extend from the spindle 18 in the horizontal direction. Meanwhile, for example, the carriage block 17 can be manufactured from aluminum by extrusion molding.

To the leading end of each carriage arm 19 is attached a head suspension 21, which extends anteriorward from the leading end of the corresponding carriage arm 19. To the leading end of each head suspension 21 is attached a flexure (not illustrated). On each flexure is defined a gimbal spring by movement of which a flying head slider 22 is allowed to change its position with respect to the corresponding head suspension 21. As described later, on each flying head slider 22 is mounted a head element that is an electromagnetic conversion element.

When each magnetic disk 14 rotates, an air current is generated at the surface of that magnetic disk 14. Due to the air current, a positive pressure, that is, a levitating force as well as a negative pressure acts on the corresponding flying head slider 22. The levitating force and the negative pressure balance a pressing force of the corresponding head suspension 21. For that reason, while the corresponding magnetic disk 14 is rotating, the flying head slider 22 continues to fly with relatively high rigidity.

If, during the flight of the flying head slider 22, the carriage 16 rotates around the spindle 18; then the flying head slider 22 is able to move along a circular arc close to the radius line of the corresponding magnetic disk 14. That makes it possible for the electromagnetic conversion element on the flying head slider 22 to move across the data zone between the innermost recording track and the outermost recording track. For that reason, the electromagnetic conversion element on the flying head slider 22 can be positioned on an intended recording track.

The carriage block 17 is connected to a power source such as a voice coil motor (VCM) 23 by the action of which the carriage block 17 can rotate around the spindle 18. The carriage arm 19 and the head suspension 21 can oscillate owing to the rotation of the carriage block 17.

As illustrated in FIG. 1, on the carriage block 17 is disposed a flexible printed board module 25 that comprises a head integrated circuit (IC) 27 mounted on a flexible printed board 26. The head IC 27 is connected to a reading element and a writing element of the electromagnetic conversion element. That connection is established using a flexible printed board 28, which is formed in continuation from each flexure. Thus, the flexible printed board 28 is connected to the flexible printed board module 25.

At the time of reading magnetic information, a sense current is supplied from the head IC 27 to the reading element of the electromagnetic conversion element. Similarly, at the time of writing magnetic information, a writing current is supplied from the head IC 27 to the writing element of the electromagnetic conversion element. The sense current is set to a certain current value. To the head IC 27, the current is supplied from a compact circuit board 29 disposed in the housing space or from a printed circuit board (not illustrated) that is fixed to the rear side of the bottom plate of the base 13.

FIG. 2 is an enlarged perspective view of a specific example of the flying head slider 22. The flying head slider 22 comprises a slider body 31 having, for example, a flat cuboid shape. On an air-outflow-side end face of the slider body 31 is laminated an element containing film 32. In the element containing film 32 is embedded an electromagnetic conversion element 33 that is the abovementioned electromagnetic conversion element. The details regarding the electromagnetic conversion element 33 are given later.

The slider body 31 can be manufactured from, for example, a hard nonmagnetic material such as a composite of alumina and titanium carbide (Al₂O₃—TiC; “AlTiC”). In comparison, the element containing film 32 can be manufactured from, for example, a relatively soft nonmagnetic insulating material such as alumina (Al₂O₃). In the slider body 31, a medium-opposing surface, that is, a floating surface 34 is the surface that lies opposite to the corresponding magnetic disk 14. On the floating surface 34 is defined a flat base surface 35 that functions as a reference surface. When the magnetic disk 14 rotates, an air current 36 acts on the corresponding floating surface 34 from the anterior end of the slider body 31 toward the posterior end thereof.

On the floating surface 34 is formed a front rail 37 that rises in a straight line from the base surface 35 at the upstream side, that is, at an air inflow side for the air current 36. The front rail 37 extends along an air inflow end of the base surface 35 in the slider width direction. Similarly, on the floating surface 34 is formed a rear rail 38 that rises in a straight line from the base surface 35 at the downstream side, that is, at an air outflow side for the air current 36. The rear rail 38 is disposed at the middle position in the slider width direction.

In addition, on the floating surface 34 is formed a left-and-right pair of side rear rails 39. Each side rear rail 39 rises from the base surface 35 at the air outflow side. Moreover, the side rear rails 39 are disposed along the right and left borders of the base surface 35. That is, a space is left in the slider width direction between the side rear rails 39. The rear rail 38 is disposed in between the pair of side rear rails 39.

On the apical surface of the front rail 37, the rear rail 38, and the pair of side rear rails 39 are defined air bearing surfaces (ABS) 41, 42, and 43. The air inflow end of each of the air bearing surfaces 41, 42, and 43 is connected to the apical surface of the rails 37, 38, and 39 by a level difference. The air current 36 generated due to the rotation of the magnetic disk 14 is received by the corresponding floating surface 34. At that time, due to level differences, a relatively high positive pressure, that is, a relatively high levitating force acts on the air bearing surfaces 41, 42, and 43. In addition, a high negative pressure acts posteriorly on the front rail 37. In other words, a high negative pressure acts at the back of the front rail 37. Based on the balance between the levitating force and the negative pressure, a floating posture of the flying head slider 22 is established. Meanwhile, the configuration of the flying head slider 22 is not limited to the description given above.

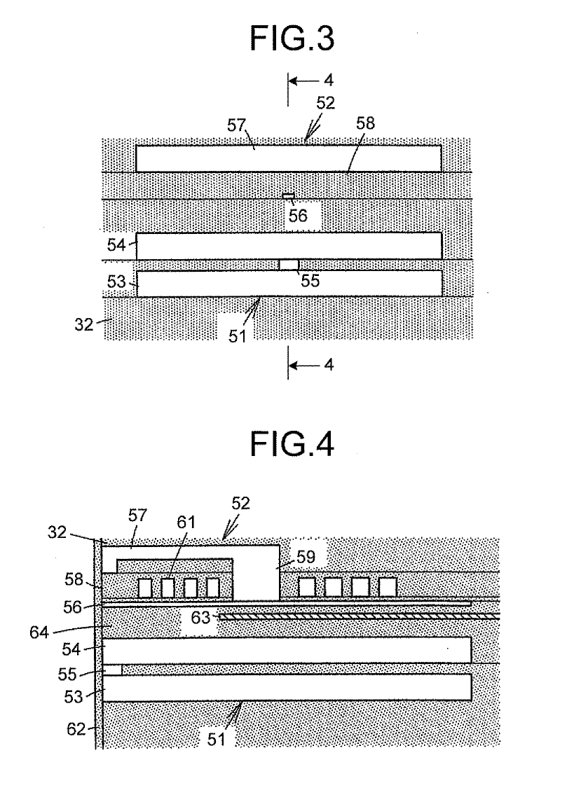

The electromagnetic conversion element 33 is illustrated in detail in FIG. 3. The electromagnetic conversion element 33 comprises a reading element 51 and a writing element 52. Herein, a tunnel magnetoresistance (TMR) effect element is used as the reading element 51. In a TMR effect element, a tunnel junction film undergoes a resistance change depending on the orientation of the magnetic field acting from the magnetic disk 14. On the basis of such resistance change, information can be read from the magnetic disks 14. Meanwhile, as the writing element 52, what is termed as a single magnetic pole head is used. The single magnetic pole head generates a magnetic field by the action of a thin-film coil pattern. Due to such generated magnetic field, information can be written in the magnetic disk 14. The electromagnetic conversion element 33 has a reading gap of the reading element 51 and a writing gap of the writing element 52 on the top surface of the element containing film 32.

In the TMR effect element, a tunnel junction film 55 that is a TMR effect film is sandwiched between a lower shield layer 53 and an upper shield layer 54 along the top surface of the element containing film 32. The anterior end of the tunnel junction film 55 is exposed at the top surface of the element containing film 32. The lower shield layer 53 and the upper shield layer 54 are manufactured from, for example, an electrically conductive magnetic material such as iron nitride (FeN) or nickel-iron (NiFe). The lower shield layer 53 and the upper shield layer 54 respectively function as an upper electrode and a lower electrode of the TMR effect element. Moreover, the distance between the lower shield layer 53 and the upper shield layer 54 determines the resolution of magnetic recording in the linear direction of the recording tracks on the magnetic disks 14. The lower shield layer 53 and the upper shield layer 54 are electrically connected to each other at the tunnel junction film 55. A sense current from the upper shield layer 54 flows toward the lower shield layer 53 through the tunnel junction film 55.

In the single magnetic pole head, on a main electrode (lower electrode) 56 is formed an auxiliary electrode (upper electrode) 57. The main electrode 56 and the auxiliary electrode 57 are manufactured from, for example, an electrically conductive magnetic material such as iron nitride (FeN) or nickel-iron (NiFe). Moreover, the main electrode 56 and the auxiliary electrode 57 are magnetically connected to each other.

As illustrated in FIG. 4, in the reading element 51, the anterior end of the lower shield layer 53 and the anterior end of the upper shield layer 54 are exposed at the top surface of the element containing film 32. The lower shield layer 53 and the upper shield layer 54 expand posteriorly from the anterior end along a virtual flat surface that is orthogonal to the top surface of the element containing film 32, that is, expand along a virtual flat surface running parallel to the air outflow side of the slider body 31. Meanwhile, in the reading element 51, the TMR effect element can be replaced by a current-perpendicular-to-plane giant magnetoresistance (CPP-GMR) effect element or a current-in-plane giant magnetoresistance (CIP-GMR) effect element. In a CPP-GMR effect element or a CIP-GMR effect element, a spin-valve film can be used as a magnetoresistance effect film.

In the writing element 52, the anterior ends of the main electrode 56 and the auxiliary electrode 57 are exposed at the top surface of the element containing film 32. The auxiliary electrode 57 expands, for example, along the top surface of the element containing film 32. Moreover, in between the auxiliary electrode 57 and the main electrode 56 is sandwiched an insulating layer 58. As illustrated in FIG. 4, the posterior end of the auxiliary electrode 57 is connected to the main electrode 56 by a magnetic connection piece 59. Around the magnetic connection piece 59, a magnetic coil, that is, a thin-film coil pattern 61 is formed. Thus, the main electrode 56, the auxiliary electrode 57, and the magnetic connection piece 59 constitute a magnetic core that runs through the center position of the thin-film coil pattern 61.

On the top surface of the element containing film 32 is formed a hard protective film 62 that covers the reading gap and the writing gap exposed at the top surface of the element containing film 32. As the protective film 62, for example, a DLC film can be used.

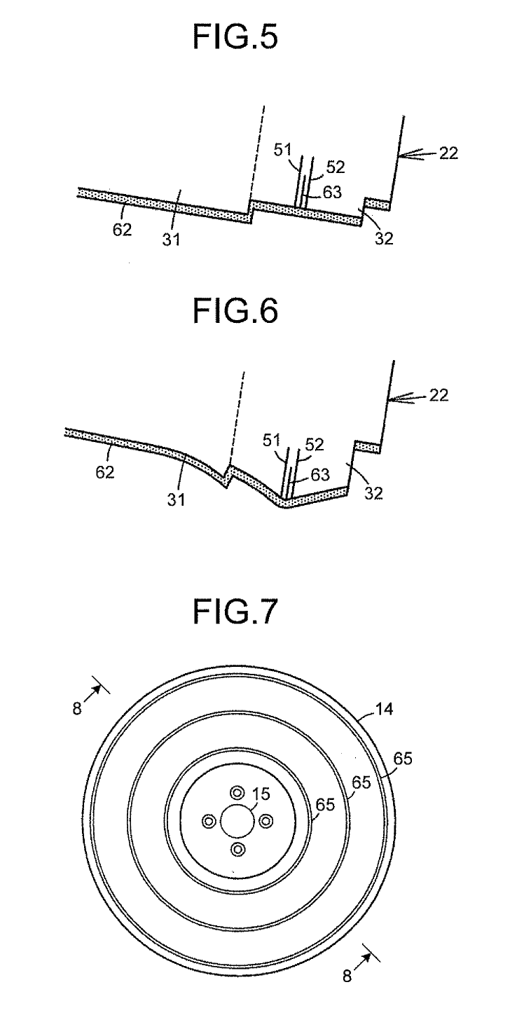

With reference to FIG. 5 in addition to FIG. 4, a heater 63 is fitted into the element containing film 32 in a corresponding manner to the electromagnetic conversion element 33. The heater 63 is made of, for example, an electrically-heated wire embedded in a nonmagnetic film 64. The electrically-heated wire can expand, for example, along a virtual flat surface that is orthogonal to the air bearing surface 42. When electric power is supplied to the heater 63, the heat generated therefrom causes heat expansion of the reading element 51 and the writing element 52. Consequently, as illustrated in FIG. 6, the electromagnetic conversion element 33 bulges at the top surface of the element containing film 32 thereby leading to the formation of what is termed as a projection. In this way, the reading element 51 and the writing element 52 change their positions toward the corresponding magnetic disk 14. Herein, for example, the flying height of the writing element 52 is determined according to the projection amount thereof.

As illustrated in FIG. 7, on the top surface of each magnetic disk 14 are formed a plurality of land regions 65 that extend in parallel in a down-track direction of the corresponding magnetic disk 14. Each land region 65 is defined in a concentric fashion with respect to the rotary shaft of the spindle motor 15. In between each pair of adjacent land regions 65 are formed a plurality of recording tracks that extend in the down-track direction of the corresponding magnetic disk 14. The details regarding the recording tracks are given later. Meanwhile, the land regions 65 are formed at an inner periphery position close to the inner edge of the corresponding magnetic disk 14, an outer periphery position close to the outer edge of the corresponding magnetic disk 14, and an intermediate position in between the inner periphery position and the outer periphery position. Herein, for example, the distance in the radial direction from the intermediate position to the inner periphery position can be set to be equal to the distance in the radial direction from the intermediate position to the outer periphery position.

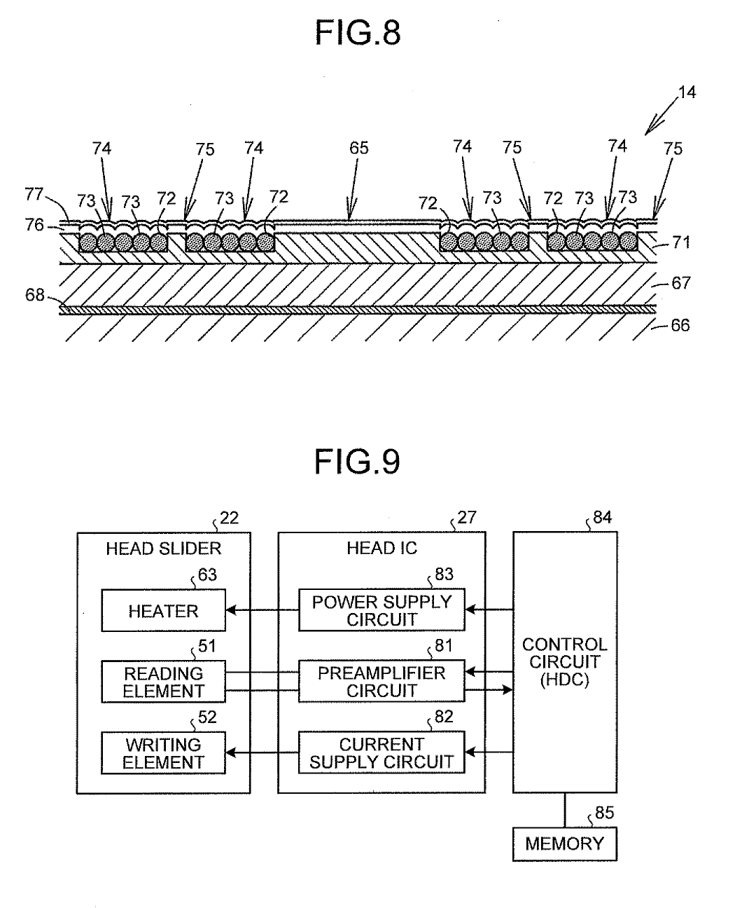

FIG. 8 is an exemplary enlarged cross-sectional view of the magnetic disk 14 according to the first embodiment. The magnetic disk 14 is configured as a perpendicular magnetic recording medium and comprises a substrate 66 that is made of, for example, a glass substrate. On each of the top and back surfaces of the substrate 66 expands a lining layer 67 that is made of, for example, a soft magnetic material such as an iron-tantalum-carbon (FeTaC) film or a nickel-iron (NiFe) film. In the lining layer 67, the axis of easy magnetization is established in an in-plane direction that is defined in parallel with the top surface of the substrate 66. In between the lining layer 67 and the substrate 66 is laid an underlayer 68 that is made of, for example, metal material of tantalum (Ta) and that enhances the adhesiveness between the lining layer 67 and the substrate 66.

On the top surface of the lining layer 67 expands an intermediate layer 71 that is made of a nonmagnetic material such as aluminum (Al). On the top surface of the intermediate layer 71 are formed a plurality of grooves 72 that extend in parallel in the down-track direction of the corresponding magnetic disk 14. Inside each groove 72 are regularly disposed, for example, a plurality of nanoparticles 73. More particularly, the nanoparticles 73 are disposed all over along the bottom surface of the corresponding groove 72. Each nanoparticle 73 at least comprises one of magnetic materials of iron (Fe), cobalt (Co) and nickel (Ni). Herein, for example, the iron-platinum (FePt) alloy is used in the nanoparticles 73. Moreover, the nanoparticles 73 are made from crystalline grains in which the axis of easy magnetization is established in the vertical direction orthogonal to the top surface of the substrate 66. In each groove 72, for example, a single bit is established by a single nanoparticle 73 and a magnetic domain is formed for each bit.

In each groove 72 is formed a groove region 74 that establishes, for example, a plurality of recording tracks. The adjacent groove regions 74 are separated by a separating track 75 that is formed by the intermediate layer 71. Each of the abovementioned land regions 65 is formed in between a predetermined pair of adjacent groove regions 74. In each land region 65, a flat surface is formed by the top surface of the intermediate layer 71. Moreover, each land region 65 expands in a cross-track direction of the corresponding magnetic disk 14 by a sufficiently larger extent as compared to the separating track 75. The top surface of the intermediate layer 71 is covered with a protective film 76 made of, for example, a DLC film and a lubricating film 77 made of, for example, a perfluoropolyether (PFPE) film. Thus, inside each groove region 74, the protective film 76 and the lubricating film 77 have surface irregularities corresponding to the shapes of the nanoparticles 73.

As illustrated in FIG. 9, in the head IC 27 are mounted a preamplifier circuit 81, a current supply circuit 82, and a power supply circuit 83. The preamplifier circuit 81 is connected to the reading element 51 and supplies the sense current toward the reading element 51. The sense current is maintained at a certain current value. The current supply circuit 82 is connected to the writing element 52 and supplies the writing current to the writing element 52. Depending on the supplied writing current, a magnetic field is generated in the writing element 52. The power supply circuit 83 is connected to the heater 63 and supplies a predetermined amount of electric power to the heater 63. The heater 63 generates heat upon being supplied with the electric power. Herein, the supplied amount of electric power determines the temperature of the heater 63. Thus, the supplied amount of electric power determines the projection amount of the electromagnetic conversion element 33.

To the head IC 27 is connected a control circuit (hard disk controller) 84 that instructs the head IC 27 to supply the sense current, the writing current, or the electric power. At the same time, the control circuit 84 detects the voltage of the sense current. Prior to the voltage detection, the preamplifier circuit 81 amplifies the voltage of the sense current. Based on the output from the preamplifier circuit 81, the control circuit 84 identifies magnetic information, which is binary information. Meanwhile, the control circuit 84 is also connected to, for example, an acoustic emission (AE) detection sensor (not illustrated) fixed to the carriage 16. For example, when the leading end of the abovementioned projection makes contact with the corresponding magnetic disk 14, the flying head slider 22 undergoes minute vibrations. At that time, ultrasonic vibrations are generated in the carriage 16 and detected by the sensor. Thus, the control circuit 84 detects the contact between the leading end of the projection and the magnetic disk 14. Meanwhile, for detecting the contact between the leading end of the projection and the magnetic disk 14, the preamplifier circuit 81 can be configured to detect the output fluctuation occurring in the reading element 51 due to the contact.

To the control circuit 84 are also connected the spindle motor 15 and the VCM 23, which are able to run by receiving the supply of electric power from the control circuit 84. The control circuit 84 controls the operations of the preamplifier circuit 81, the current supply circuit 82, and the power supply circuit 83 based on a predetermined software program that can be stored in a memory 85, for example. The zero calibration described hereinafter is performed according to the software program. The memory 85 can be used to store necessary data to perform the zero calibration. Thus, the software program or the data can be transferred from another storage medium into the memory 85. Meanwhile, the control circuit 84 and the memory 85 can be mounted on the circuit board 29.

Consider the case of performing the zero calibration in the HDD 11. In the zero calibration, the projection amount of the writing element 52 is set prior to the reading or writing of magnetic information. To set the projection amount of the writing element 52, the projection amount of the electromagnetic conversion element 33 is measured when the leading end of the projection makes contact with the magnetic disk 14. Based on the projection amount of when the leading end of the projection makes contact with the magnetic disk 14, the projection amount of the electromagnetic conversion element 33 for the time of reading or writing is set. By setting the projection amount of the electromagnetic conversion element 33 for the time of reading or writing, it becomes possible for the electromagnetic conversion element 33, that is, the writing element 52 to fly by a predetermined flying height from the top surface of the magnetic disk 14. Meanwhile, the zero calibration as described above can be performed, for example, every time the HDD 11 is started.

In order to perform the zero calibration, the control circuit 84 executes a predetermined software program. Upon execution of the software programs, the control circuit 84 instructs the spindle motor 15 to run. The magnetic disk 14 rotates at a predetermined rotation speed. At the same time, the control circuit 84 instructs the VCM 23 to run. The carriage 16 oscillates around the spindle 18. As a result, the flying head slider 22 is made to face the magnetic disk 14. Then, the flying head slider 22 flies by a predetermined flying height from the top surface of the magnetic disk 14. At that time, according to the oscillation of the carriage 16, the electromagnetic conversion element 33 mounted on the flying head slider 22 is positioned above the land region 65.

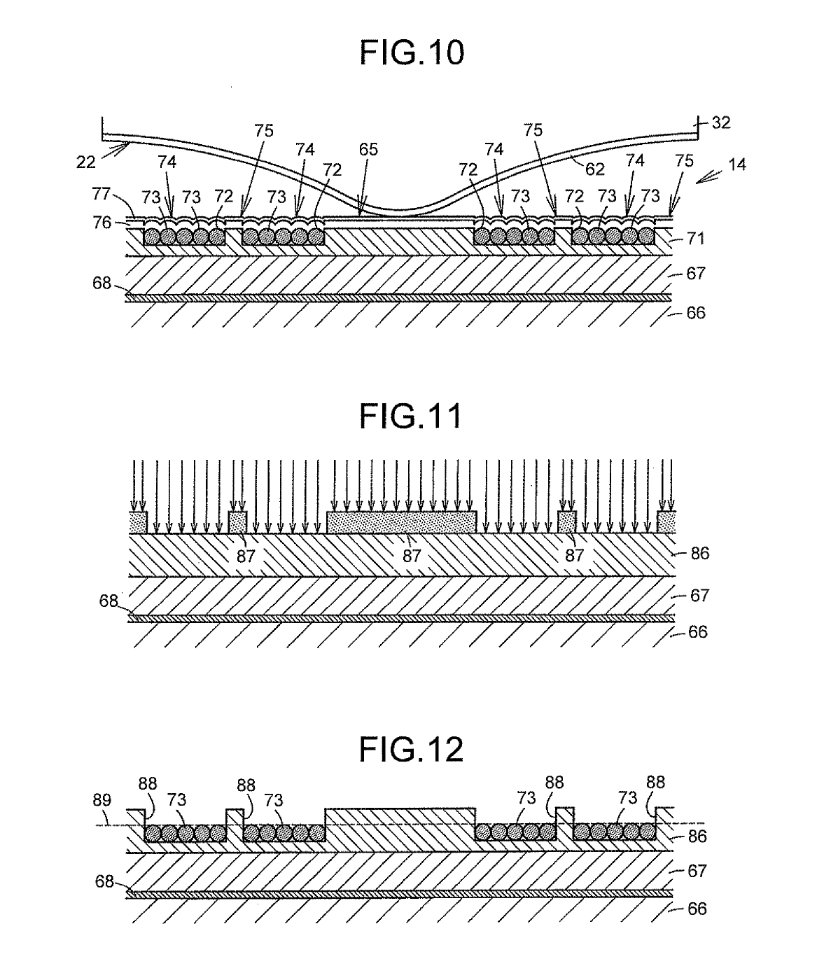

Upon completion of the positioning, the control circuit 84 issues a command signal to the power supply circuit 83. Herein, the control circuit 84 increases the projection amount of the electromagnetic conversion element 33 by a specified increment. Thus, depending on the received command signal, the power supply circuit 83 supplies, to the heater 63, electric power proportionate to the increased projection amount. In this manner, as the projection amount of the electromagnetic conversion element 33 increases, the projection thereof makes contact with the flat surface on the land region 65 as illustrated in FIG. 10. Because of the contact, the flying head slider 22 vibrates. The detection sensor fixed to the carriage 16 detects the ultrasonic vibrations in the carriage 16 and notifies the detection of the contact to the control circuit 84. Based on the output from the detection sensor, the control circuit 84 detects the contact between the projection and the magnetic disk 14.

Upon detection of the contact, the control circuit 84 reduces the projection amount of the electromagnetic conversion element 33. The decrement in the projection amount is set to be smaller than the abovementioned increment in the projection amount. Then, based on the oscillation of the carriage 16, the control circuit 84 positions the electromagnetic conversion element 33, which is mounted on the flying head slider 22, above the groove region 74. While reducing the projection amount of the electromagnetic conversion element 33, the control circuit 84 instructs the reading element 51 to read binary information from the nanoparticles 73. Then, depending on the size of the binary information, the control circuit 84 determines the projection amount of the electromagnetic conversion element 33. The amount of electric power supplied to the heater 63 is maintained according to the determined projection amount. Meanwhile, the relation between the binary information and the projection amount of the electromagnetic conversion element 33 can be stored in, for example, the memory 85. As mentioned above, the zero calibration is completed.

In the HDD 11 described above, the electromagnetic conversion element 33 is caused to have a projection above the land region 65. The leading end of the projection makes contact with the flat surface on the land region 65. Hence, at the leading end of the projection, the wear of the protective film 62 is curbed. That makes it possible to significantly curb the damage to the protective film 62 and thus avoid any damage to the electromagnetic conversion element 33. In contrast, if the electromagnetic conversion element 33 is caused to have a projection above the groove region 74, then the leading end of the projection makes contact with surface irregularities corresponding to the shapes of the nanoparticles 73. In that case, the protective film 62 undergoes wear at the leading end of the projection thereby causing premature damage to the electromagnetic conversion element 33.

Explained below is a method for manufacturing the magnetic disk 14. Firstly, on the top surface of the substrate 66 are formed the underlayer 68 and the lining layer 67 in a laminated manner. As illustrated in FIG. 11, on the top surface of the lining layer 67 is formed an aluminum (Al) film 86 having a uniform film thickness. On the top surface of the Al film 86 is formed a resist film 87 with outlines of the land regions 65 modeled thereon. On the top surface of the Al film 86 and at the outside of the resist film 87, etching processing is performed so that grooves 88 are formed on the Al film 86 as illustrated in FIG. 12. The grooves 88 are filled with the nanoparticles 73. The top surface of the Al film 86 is subjected to flattening processing along a virtual flat surface 89 running parallel to the top surface of the substrate 66. On each land region 65 is formed a flat surface. In this manner, the intermediate layer 71 is formed. Then, on the top surface of the intermediate layer 71 are formed the protective film 76 and the lubricating film 77. Thus, inside each groove region 74, the protective film 76 and the lubricating film 77 have surface irregularities corresponding to the shapes of the nanoparticles 73.

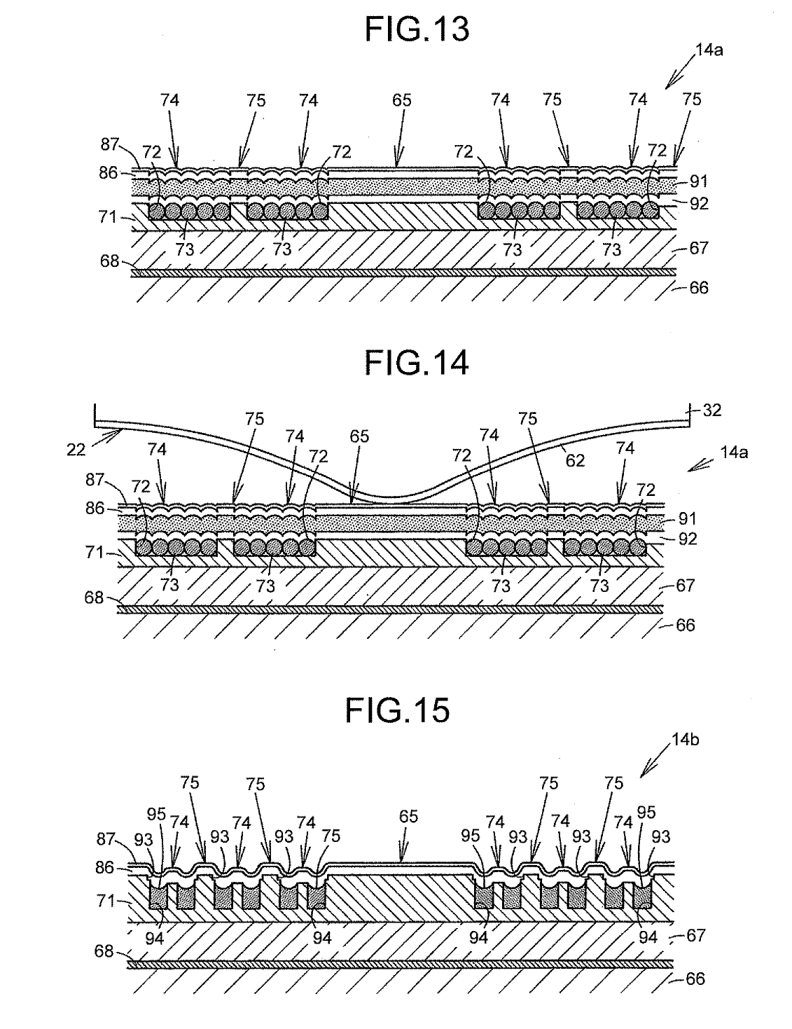

FIG. 13 is an exemplary enlarged cross-sectional view of a magnetic disk 14a according to a second embodiment. In the magnetic disk 14a, on the top surface of the intermediate layer 71 is formed a magnetic layer 91 having a soft magnetic property. The magnetic layer 91 is formed with a continuous film expanding over the entire top surface of the intermediate layer 71. In the magnetic layer 91 is recorded predetermined binary information. In the magnetic layer 91, a magnetic domain is formed for each bit. In each bit, the axis of easy magnetization is established in the vertical direction orthogonal to the top surface of the substrate 66. Herein, in the bits arranged in the vertical direction orthogonal to the top surface of the substrate 66, the magnetic domains are formed along the same direction.

The magnetic layer 91 rests on a coupling layer 92 that expands over the entire top surface of the intermediate layer 71 and that is made of a nonmagnetic material such as ruthenium (Ru). In each groove region 74, the coupling layer 92 is sandwiched between the nanoparticles 73 and the magnetic layer 91. Moreover, in each groove region 74, the magnetic layer 91 and the coupling layer 92 have surface irregularities corresponding to the shapes of the nanoparticles 73. The magnetic disk 14a constitutes what is known as a coupled granular continuous (CGC) medium or an exchange coupled composite (ECC) medium. Apart from that, in the magnetic disk 14a, the same reference numerals are used for referring the constituent elements or the structures that are identical to those in the magnetic disk 14.

As illustrated in FIG. 14, in the zero calibration, the electromagnetic conversion element 33 is positioned above the land region 65 as described above. Then, with an increase in the projection amount of the electromagnetic conversion element 33, the projection thereof makes contact with the flat surface on the land region 65. Upon detection of the contact between the projection and the magnetic disk 14a, the control circuit 84 reduces the projection amount of the electromagnetic conversion element 33 above the land regions 65. At the same time, the control circuit 84 instructs the reading element 51 to read binary information from the magnetic layer 91. Then, depending on the size of the binary information, the control circuit 84 determines the projection amount of the electromagnetic conversion element 33. For the determination of the projection amount, it is possible to make use of, for example, the Wallace formula. The amount of electric power supplied to the heater 63 is maintained according to the determined projection amount. This marks the end of the zero calibration.

In such a configuration of the HDD 11, in an identical manner to the description given above, the electromagnetic conversion element 33 is caused to have a projection above the land region 65 and the leading end of the projection makes contact with the flat surface on the land region 65. Hence, at the leading end of the projection, the wear of the protective film 62 is curbed. That makes it possible to significantly curb the damage to the protective film 62 and thus avoid any damage to the electromagnetic conversion element 33. In addition, since the magnetic disk 14a comprises the magnetic layer 91 that expands over the entire top surface of the intermediate layer 71, the projection amount of the electromagnetic conversion element 33 is determined according to the binary information read from the magnetic layer 91 above the land region 65. Hence, at the time of determining the projection amount, the electromagnetic conversion element 33 need not be moved above the groove region 74. Besides, because of the magnetic layer 91, the magnetic disk 14a constitutes a CGC medium or an ECC medium. As a result, based on the control of magnetic exchange interaction between the nanoparticles 73, the magnetic property and the recording property of the magnetic disk 14a as well as the thermal stability of the magnetic disk 14a are controlled.

FIG. 15 is an exemplary enlarged cross-sectional view of a magnetic disk 14b according to a third embodiment. In the magnetic disk 14b, grooves 93 are formed instead of the grooves 72 on the top surface of the intermediate layer 71. The grooves 93 extend in the down-track direction of the magnetic disk 14b. In each groove 93 are formed nanoholes 94 that are arranged in the cross-track direction of the magnetic disk 14b and that are filled with a magnetic material 95 of, for example, cobalt (Co). The arrangement of the nanoholes 94 results in the formation of recording tracks. Herein, in each groove 93 are formed two rows of recording tracks in the cross-track direction. Moreover, in each groove 93 is formed the groove region 74. The adjacent groove regions 74 are separated by the separating tracks 75. Each of the land regions 65 is formed in between a predetermined pair of adjacent groove regions 74. Apart from that, in the magnetic disk 14b, the same reference numerals are used for referring the constituent elements or the structures that are identical to those in the magnetic disk 14 and the magnetic disk 14a.

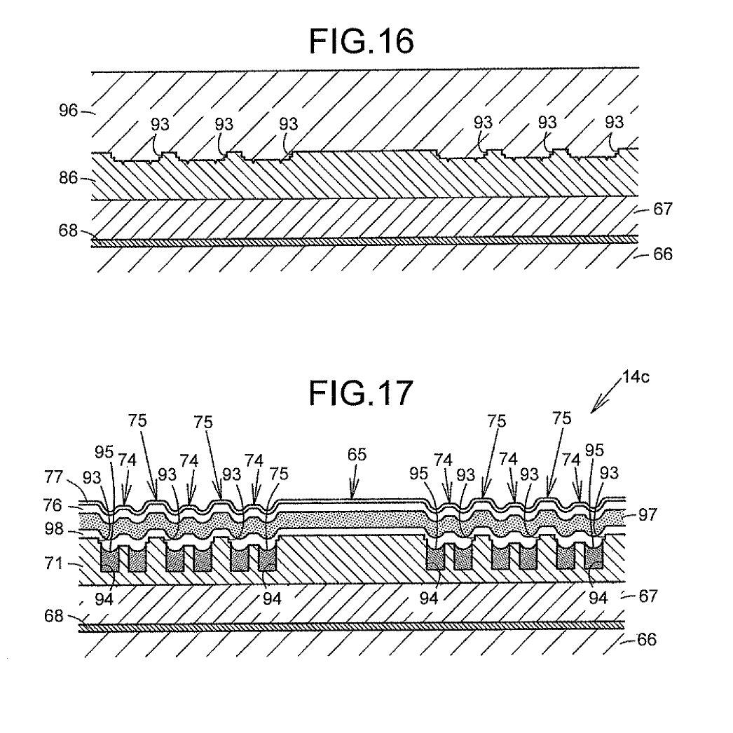

In such a configuration of the magnetic disk 14b, on the top surface of the substrate 66 are formed the underlayer 68 and the lining layer 67 in a laminated manner. As illustrated in FIG. 16, on the top surface of the lining layer 67 is formed the Al film 86. Moreover, on the top surface of the Al film 86 is pressed a mold 96 to transfer a pattern. In this manner, the grooves 93 are formed on the top surface of the Al film 86. When the mold 96 is removed from the Al film 86, anodic oxidation causes the formation of the nanoholes 94 in the grooves 93. The nanoholes 94 are filled with the magnetic material 95. Subsequently, the top surface of the Al film 86 is subjected to flattening processing so that the overflowing magnetic material is wiped off and the intermediate layer 71 is formed. On the top surface of the intermediate layer 71 are formed the protective film 76 and the lubricating film 77. In this manner, the magnetic disk 14b is manufactured.

In such a configuration of the HDD 11, in an identical manner to the magnetic disk 14, the electromagnetic conversion element 33 is caused to have a projection above the land regions 65. Then, with an increase in the projection amount, the leading end of the projection of the electromagnetic conversion element 33 makes contact with the flat surface on the land region 65. Hence, at the leading end of the projection, the wear of the protective film 62 is curbed. That makes it possible to significantly curb the damage to the protective film 62 and thus avoid any damage to the electromagnetic conversion element 33. Upon detection of the contact, the control circuit 84 reduces the projection amount of the electromagnetic conversion element 33 and positions the electromagnetic conversion element 33 above the groove region 74. At the time of reducing the projection amount of the electromagnetic conversion element 33, the reading element 51 reads binary information from the nanoparticles 73. Then, depending on the size of the binary information, the projection amount of the electromagnetic conversion element 33 is determined.

FIG. 17 is an exemplary enlarged cross-sectional view of a magnetic disk 14c according to a fourth embodiment. In the magnetic disk 14c, on the top surface of the intermediate layer 71 is formed a magnetic layer 97 having a soft magnetic property. The magnetic layer 97 is formed with a continuous film expanding over the entire top surface of the intermediate layer 71. In the magnetic layer 97 is recorded predetermined binary information. In the magnetic layer 97, a magnetic domain is formed for each bit. In each bit, the axis of easy magnetization is established in the vertical direction orthogonal to the top surface of the substrate 66. Herein, in the bits arranged in the vertical direction orthogonal to the top surface of the substrate 66, the magnetic domains are formed along the same direction.

The magnetic layer 97 rests on a coupling layer 98 that expands over the entire top surface of the intermediate layer 71 and that is made of a nonmagnetic material such as ruthenium (Ru). In each groove region 74, the coupling layer 98 is sandwiched between the nanoparticles 73 and the magnetic layer 97. Moreover, in each groove region 74, the magnetic layer 97 and the coupling layer 98 have surface irregularities corresponding to the shapes of the nanoparticles 73. Such a configuration of the magnetic disk 14c constitutes what is known as a CGC medium or an ECC medium. Apart from that, in the magnetic disk 14c, the same reference numerals are used for referring the constituent elements or the structures that are identical to those in the magnetic disk 14.

In such a configuration of the HDD 11, in the zero calibration, the electromagnetic conversion element 33 is positioned above the land regions 65 as described with reference to the magnetic disk 14a. Then, the projection makes contact with the flat surface on the land region 65. Hence, at the leading end of the projection, the wear of the protective film 62 is curbed. That makes it possible to significantly curb the damage to the protective film 62 and thus avoid any damage to the electromagnetic conversion element 33. In addition, since the magnetic disk 14c comprises the magnetic layer 97 that expands over the entire top surface of the intermediate layer 71, the projection amount of the electromagnetic conversion element 33 is determined according to the binary information read from the magnetic layer 97 above the land regions 65. Hence, at the time of determining the projection amount, the electromagnetic conversion element 33 need not be moved above the groove region 74. Besides, because of the magnetic layer 97, the magnetic disk 14a constitutes a CGC medium or an ECC medium. As a result, based on the control of magnetic exchange interaction between the nanoparticles 73, the magnetic property and the recording property of the magnetic disk 14c as well as the thermal stability of the magnetic disk 14c are controlled.

In this way, such a magnetic recording medium can make a substantial contribution in achieving the recording medium driving device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording medium driving device comprising:
a recording medium comprising a plurality of groove regions and a plurality of land regions, wherein each of the groove regions is formed in a groove that is formed on a top surface of the recording medium and that has an arrangement of a magnetic domain formed for each bit, and each of the land regions forms a flat surface on the top surface of the recording medium and in between a pair of the groove regions;
a head slider disposed to face the top surface of the recording medium;
a head element mounted on the head slider;
a heater mounted on the head slider and that is configured to cause a projection in the head element by heat; and
a controller configured to cause the projection of the head element to contact with the land region at time of performing zero calibration for the projection.

2. The recording medium driving device of claim 1, wherein the controller is configured to determine a projection amount of the head element depending on an output of magnetic information that is read from the groove region by the head element.

3. The recording medium driving device of claim 1, further comprising a magnetic layer on the top surface of the recording medium within the land region, and that is configured to store magnetic information, wherein
the controller is configured to determine a projection amount of the head element depending on an output of magnetic information that is read from the magnetic layer by the head element.

4. A head-element flying height control method comprising:
positioning a head slider on a land region, the land region forming a flat surface on a top surface of a recording medium, and in between each pair of adjacent groove regions from among a plurality of groove regions each formed in a groove that is formed on the top surface of the recording medium and that has an arrangement of a magnetic domain formed for each bit; and
causing a projection of a head element mounted on the head slider to contact with the land region by increasing a projection amount of the head element.

5. The head-element flying height control method of claim 4, further comprising:
reading, while reducing the projection amount of the head element after the projection contacts with the land region, magnetic information from the groove region by the head element; and
determining the projection amount of the head element depending on an output of the read magnetic information.

6. The head-element flying height control method of claim 4, further comprising:
reading, while reducing the projection amount of the head element after the projection contacts with the land region, magnetic information from a magnetic layer that is formed on the top surface of the recording medium within the land region; and
determining the projection amount of the head element depending on an output of the read magnetic information.

7. A magnetic recording medium comprising:
a substrate;
a plurality of groove regions, each groove region being formed in a groove that is formed on a top surface of the substrate and that has an arrangement of a magnetic domain formed for each bit;
a plurality of land regions, each land region forming a flat surface on the top surface of the substrate and in between a pair of the groove regions; and
a magnetic layer that is formed on the top surface of the substrate within the land region and that is configured to store magnetic information.
